(19) United States
(12) Patent Application Publication
(10) Pub. No.: US 2019/0005511 A1
(43) Pub. Date: Jan. 3, 2019

(54) INDICATIONS OF STATUS OF PACKAGED PRODUCT

(71) Applicant: HP Indigo B.V., Armstelveen (NL)

(72) Inventor: Gideon Amir, Ness Ziona (IL)

(73) Assignee: HP Indigo B.V., Amstelveen (NL)

(21) Appl. No.: 15/748,632

(22) PCT Filed: Dec. 21, 2015
(86) PCT No.: PCT/EP2015/080836

§ 371 Date: Jan. 29, 2018

(51) Int. Cl. G06Q 30/00; G06Q 10/08

(52) U.S. Cl. CPC G06Q 30/0185; G06Q 10/08

(57) ABSTRACT

In an example, a method comprises acquiring a machine readable first identifier associated with a packaged product. A database may be queried using the first identifier to determine distribution data, the distribution data comprising at least one of a destination region and an origin region. At least one of a destination region and an origin region may be acquired from the packaged product as machine readable data. At least one acquired region may be compared with the distribution data. As a result of a determined correspondence or non-correspondence between the regions, an indication of at least one of a counterfeit status, a diversion status and a valid status for the packaged product may be determined.

### BACKGROUND

Goods in transit may be associated with identifiers, for example reference numbers, bar codes, Radio Frequency Identifier (RFID) tags, Quick Response (QR) codes or the like. In some examples, the identifiers are used to track the location of products at stages throughout the transit thereof. In some examples, the codes are used to identify counterfeit items. For example, a counterfeit item may bear an invalid code. If the code is found to be invalid at a check point, the item could be further inspected.

### BRIEF DESCRIPTION OF DRAWINGS

Non-limiting examples will now be described with reference to the accompanying drawings, in which:

FIG. 1 is a flowchart of an example of a method for use in association with packaged products;

FIG. 2 is a flowchart of an example of a method of determining an indication of at least one of a counterfeit status, a diversion status and a valid status associated with a packaged product;

FIG. 3 is a matrix associating region mismatches with a likelihood of diversion and/or counterfeiting according to an example;

FIG. 4 is a flowchart of another example of a method for use in association with packaged products; and

FIG. 5 a simplified schematic of an example of processing apparatus.

### DETAILED DESCRIPTION

FIG. 1 shows an example of a method comprising, in block 102, acquiring a machine readable first identifier associated with a packaged product. The product may be packaged in the sense of being part of a shipment, for example within a container with other products or may be packaged in the sense of being prepared for transport in some other way, for example the product itself may bear an address label. For the avoidance of any doubt, the term ‘shipment’ as used herein encompasses all methods of goods transport, including air, land and sea. In some examples, the first identifier may comprise an identifier which uniquely identifies an instance of a product. In some examples, the first identifier may be provided as a coded pattern, for example a bar code or QR code, and may be printed on the packaged product (either on the exterior of shipping packaging, or on a product within the shipping packaging). In such examples, acquiring the machine readable first identifier may comprise acquiring an image of the coded pattern and deriving the first identifier therefrom, for example through use of a lookup table. Optical Character Recognition (OCR) may be used to acquire a displayed alphanumeric identifier in a machine readable form. In other examples, the first identifier may be provided in a machine readable form associated with the packaged product, for example as an RFID tag. In other examples, the first identifier may be input manually, for example being read from a packaged product by an inspector thereof and entered into a processing or computing apparatus using a keyboard or the like.

In block 104, a database is queried using the first identifier to determine corresponding distribution data. Such distribution data may comprises information about the transit of the product, i.e. its distribution routes. The distribution data comprises at least one of a destination region and an origin region. Such regions may be provided as street addresses, or to identify a region, such as a city or postal code or the like. In some examples, the database which is queried is associated with a product controlling entity, for example, a product manufacturer, brand owner, distributor or any (in some examples, any trusted or validated) entity with knowledge of the intended shipping route and/or authorised distribution regions of particular products (for example, an entity which has authorised or instructed the transport, or an entity which has received information thereof from a trusted entity such as an authorised distributor). In some examples, the product controlling entity may be identified using a second identifier, as is discussed in greater detail in relation to FIG. 4 below.

In block 106, the method comprises acquiring at least one of a destination region and an origin region from the packaged product as machine readable data. Such regions may be provided as, or extracted from, street addresses. Such regions may identify a geographical or postal region, such as a city or postal code or the like. In some examples, acquiring the region as machine readable data may comprise converting an image of at least one of a destination address and an origin address displayed on the packaged product into machine readable data, for example using OCR techniques. In other examples, the region(s) may be input manually. In other examples the regions may be acquired using a shipping reference number or the like, for example from a shipment identifier (which may for example comprise a Global Shipment Identification Number GSIN, which may in turn be encoded as a barcode). In some such examples, the shipment identifier may be associated with a region via a database or the like, and the region may be acquired by querying a database.

Block 108 comprises comparing at least one said region against the regions provided as distribution data and, as a result of the comparison, determining an indication of at least one of a counterfeit status, a diversion status and a valid status. For example this may result in a determination of at least one likelihood that the packaged product is counterfeit, diverted or is validly transmitted. A diverted product is a genuine product which is on route to an unauthorised location.

As mentioned above, in some examples, a region may be extracted from an address, such as the destination address, displayed on or otherwise acquired from the packaged product. For example, the address may be a street address including a region such as a city or a country, and the comparison in block 108 may be made between the city/country from the address acquired from the packaged product and a region stored in the database. Comparing the regions at this level (as compared to, for example, a street address level) may allow, for example, for shipments by resellers within an authorised region. For example, a product controlling entity may transport a product to a first destination, for example a distribution point or warehouse or the like, and may authorise further distribution of the product within a region, such as the country in which the warehouse is situated. The product controlling entity may therefore be aware of the full address of the first destination but an indication that the packaged product may be on route to another destination within the region may be innocent.

By comparing region data, risks of both diversion and counterfeiting may be determined during transit of the object. This may mean that the risks are identified earlier than in other systems, which rely on inspection of the product at the point of sale. Moreover, instead of relying on an identifier, which has been proposed in other systems, the method of FIG. 1 considers origin and delivery addresses/regions. Therefore, if a product has an associated identifier which may be valid in the sense of having been copied from a valid product, for example, and may therefore be recognised by a product controlling entity, the product may nevertheless be identified as suspect by comparing the region data. Moreover, as the data acquired from the product may be compared to data acquired from the product controlling entity in some examples, this data may be trusted.

The method of FIG. 1 may be carried out or initiated at a transit point, such as a port or other transit hub, or an inspection point such as an international border or the like. In some examples, the method may be initiated by a package handling authority such as an inspector, who may acquire the identifier and the address regions from the packaged product, for example using a handheld processing device. This data may be processed locally, for example on the device or on a computing device local thereto. In other examples, the data may be transmitted to the storage location of the database. In some examples, a determined status indication may be determined at or transmitted back to the transit or inspection point, allowing suspect goods to be identified and for example impounded or the like during transit thereof.

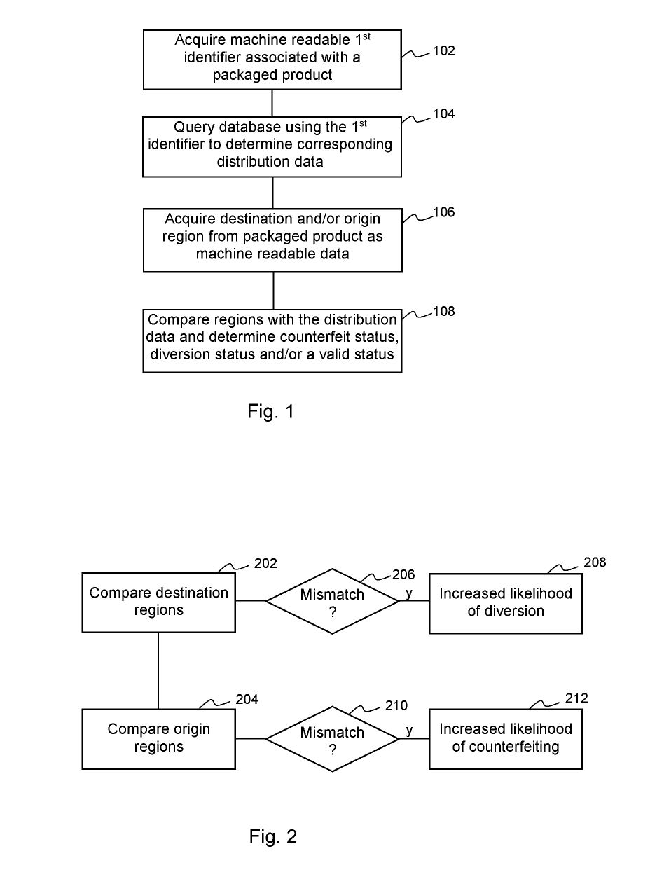

FIG. 2 comprises an example of a method of carrying out block 108 of FIG. 1. In block 202, the destination region acquired from the package is compared (by a processing apparatus) with the destination region supplied with the distribution data. In block 204, the origin region displayed on the package is compared (by a processing apparatus) with the origin region supplied with the distribution data.

A likelihood that the packaged product is counterfeit, diverted, or valid is based on whether: one of said regions matches the distribution data; both of said regions match the distribution data; or neither of the regions match the distribution data. More particularly, in this example, the counterfeit status, diversion status and/or valid status of the package is determined as an indication of likelihood that a shipment is diverted, counterfeit, or valid, wherein, if there is a mismatch between the destination region of the packaged product and the destination region in the distribution data (block 206), an increased likelihood of diversion is determined (block 208); and if there is a non-correspondence between the origin region of the packaged product and the origin region in the distribution data (block 210), an increased likelihood of counterfeiting is determined (block 212). However, the increase in risk of diversion and counterfeiting is not mutually exclusive: for example, in some cases, if there is a non-correspondence between the origin region of the packaged product and the origin region in the distribution data (block 210), an increased likelihood of diversion is also determined.

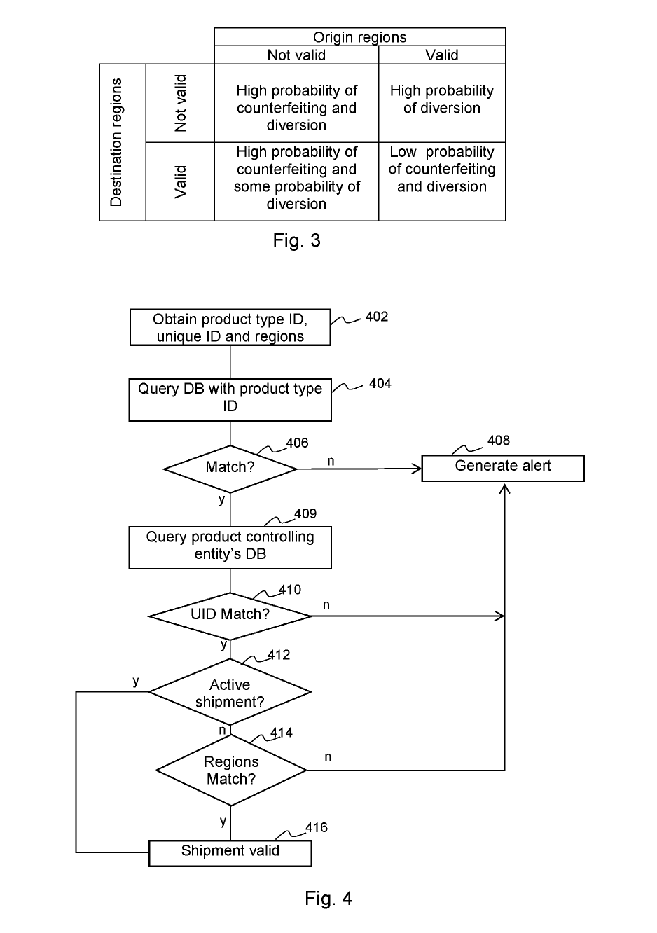

FIG. 3 shows an example of how the matches/mismatches (i.e. a correspondence or non-correspondence) may be used to determine likelihoods. In this example, if there is a mismatch or non-correspondence between the origin regions and a match or correspondence between the destination regions, a high likelihood that the shipment is counterfeit is determined. If there is a mismatch between the destination regions and a match between the origin regions, a high likelihood that the shipment is diverted is determined. If there is a mismatch between origin region and between and destination regions, a high likelihood that the shipment is diverted or counterfeit is determined.

A further example is now discussed with reference to the flowchart of FIG. 4. In block 402, a plurality of identifiers are obtained from a packaged product. In this example, the identifiers comprise a product type identifier identifying a product type (for example, a bar code, which may be a universal product code (UPC), indicating the product type, for example that the product is a 500 ml bottle of a particular perfume) and a unique ID (UID), uniquely identifying the instance of the product (e.g., to continue the above example, identifying a particular bottle of perfume). In an example, the UID provides a first identifier, as described in relation to FIG. 1, and the product type identifier comprises a second identifier. An origin and destination region are also obtained.

In block 404, the product type identifier (i.e. the second identifier) is used to identify the product controlling entity, which may be a manufacturer, or some other entity with knowledge of the intended shipping route and/or authorised distribution regions, from a database (DB). If, in block 404, no mention of the product can be found, it may be determined that the product type ID is false, and, in block 408, an alert is generated. In some identifier systems (such as the Universal Product Code system, UPC), every product to be validly sold is intended to have a product code. Therefore, the absence of a valid product type identifier indicates with a high level of certainty that the product is at least suspect. In some examples, the alert generated in block 408 may be an indication of a likelihood (in this example, a high, or very high likelihood that the product is counterfeit). In some examples, the alert may be an alarm, or a notification, which may be issued to the product controlling entity and/or to the entity initiating the enquiry, which may be a port authority, a postal authority, a border authority or the like. In some examples, the package may be flagged for inspection, or flagged to be impounded or the like, such that normal onwards transit of the packaged product is prevented. In this circumstance, this alert may indicate that the product is suspect with a high certainty, as the product type identifier is unknown. Therefore, this may be indicative of a false or generated identifier.

If, however, in block 406, the product controlling entity is identified using the second, product type, identifier, a corresponding database may be queried in block 408 based on the first identifier. The product controlling entity in an example may for example be the original manufacturer, i.e. the source of the packaged product, or may be in other examples any other product controlling entity, such as a brand holder, a distribution company (which may be an authorised distribution company), or the like. In some examples, a product controlling entity, identified using the product type identifier, may provide a database, or a dataset for a database, or else may provide access to a database. As the data originates from the product controlling entity identified by the product type ID, the data may be considered to be reliable.

In block 409, the product controlling entity's database (i.e. a database controlled by, or based on information provided by, a product controlling entity) is queried based on the unique identifier and the regions acquired from the packaged product. Querying the product controlling entity's database may comprise sending a query request to, for example, a manufacturer's database, or may comprise accessing a database held elsewhere, for example as part of a processing system providing the method. Such a database may be periodically synchronized with the product controlling entity's information. In some examples, the database may comprise a plurality of datasets relating to different product control entities associated with different products), and querying the database may comprise querying the dataset associated with the product controlling entity identified by the product type identifier. Therefore, in some examples, the database queried with the first identifier (the UID) is distinct from that queried with the second identifier (the product type identifier), and/or may be provided from a distinct source.

If, in block 410, the unique product identifier (UID), or first identifier, is found in the product controlling entity's database (i.e. the UID is known to the product controlling entity), it is determined whether the product associated with that UID is in an active shipment (block 412). In this example, if the UID is found and is determined to be in active shipment, it may be concluded that the likelihood that the product is diverted or counterfeit is low, as the chances that an unauthorised party will transmit a product with the same UID at the same time as the product controlling entity transmits the genuine product is low. It may be noted that, in FIGS. 2 and 3, the risks associated with, for example, an incorrect destination address were given as being high. However, in this example, as the packaged product is identified as being validly in an active shipment the risk of diversion is assumed to be low, without reference to the addresses/regions. Not all region discrepancies will be an indication of an unauthorised shipment. For example, the regions may not match up due to database error, or due to a forwarding of the product by an authorised reseller, or the destination region in the database may be an intermediate destination, for example, and therefore it is not certain that a product having a non-matching destination region is diverted in all examples.

The designation of a risk level may depend on various factors, and may for example be set by the product controlling entity with knowledge of the likely routes of diversion for that product type.

In this example, the finding that the UID is associated with a product in active shipment leads to a conclusion in block 416 that the shipment is valid with respect to this product. If there is no match determined in block 410 (the unique product identifier (UID) is not found in the product controlling entity's database), then it may be determined that the UID is very likely to be false, and, in block 408, an alert is generated as discussed above.

If the UID is found in the product controlling entity's database in block 410, but it is found in block 412 that the product associated with that UID not indicative of an active shipment, it is considered whether the origin and destination regions acquired from the product match the origin and destination regions provided in the product controlling entity's database (block 414). It may be the case that the UID is (innocently) missing from a product controlling entity's database as being in active shipment on the basis that it is being further transported by an authorised reseller or the like. Therefore, in this example, it is considered whether the product remains in an authorised region for reselling. This increases the flexibility of the system and prevents products which are in authorised transit from being unnecessarily flagged as suspect. In some examples, the address labels are scanned and OCR techniques are used to acquire the addresses (and in some examples, regions are extracted therefrom). In other examples, another indication, for example a shipment identifier (which may for example comprise a Global Shipment Identification Number GSIN, which may in turn be encoded as a barcode) may be used to query a database held or supplied by a shipping company or the like, which may return the regions. The regions from the product controlling entity's database are compared to regions acquired from the packaged product.

For example, this may comprise querying a product controlling entity's database holding origin and destination regions. The regions may for example comprise defined geographical areas, at any granularity from a continent to a street address. In some examples, the database may hold a nested list. For example, for each country there may be a list of States/Provinces/Regions, for each State/Province/Region there may be a list of cities, and for each city, there may be a list of postal codes (e.g. ZIP numbers). In such examples, it may be determined for example if the postal code on the packaging matches an origin or delivery postal code of the product type. The match may be made at the level of a street address, or at a different level, such as city. The regions may be identified using a first identifier (UID) or the second identifier (for example, if the UID is not contained in the database). There may be more than one region (which may be geographically separated) in the database, and a match may be determined based on a match between the region acquired from the product and any region held in the product controlling entity's database in association with the UID.

If there is a match for both regions determined in block 414, this is indicative of a low risk of counterfeiting and a low risk of diversion. In this example, this leads to a conclusion that the shipment is valid with respect to this product (block 416). In particular, as the product was sent from a region associated with the product controlling entity to a region which is the intended region, then the risk of both diversion and counterfeiting is low. Therefore, in this example, either an indication that the packaged product is in active shipment (block 412) or, failing that, an indication that the regions match (block 414), is associated with a low risk of both counterfeiting and diversion.

If there is no match in block 414, this is an indication that the item is suspect, as at least one of the origin region and the destination region are not as expected, and the product is not identified as being in active shipment. In this example, the method continues by generating an alert (block 408).

In an example, if the origin region does not match and the destination region does match, the counterfeit likelihood may be deemed to be relatively high (as the product has not come from an expected originating region of the manufacturer) and the diversion likelihood may be deemed to be a relatively low (although in some examples, this may be non-zero level, i.e. the product is likely counterfeit and may be diverted). If the origin region matches and the destination region does not match, a high risk of diversion is determined. If neither regions match, the likelihood of both counterfeiting and diversion is deemed to be high.

As noted above, in this example, it may be the case that if the product is deemed to be in active shipment, there is no validation carried out using the regions. However, in other examples, such validation may be carried out, for example based on user specifications.

In other examples, the queried database (i.e. the product controlling entity's database) may contain UIDs relating to products which are in active shipment, and not others. In that case, block 410 and 412 maybe effectively merged. In some cases, in such an example, the absence of the UID in an ‘active shipment’ database may indicate that the product is suspect. In other cases, the regions may also be checked, for example using the product type identifier to identify valid regions for that product type, to form a conclusion in relation counterfeiting and/or diversion.

A level of risk may be deemed to be ‘very high’, ‘high’ ‘low’ or ‘very low’. An unrecognised UID may be associated with a very high likelihood of counterfeiting. A valid UID and/or a match on both regions may be associated with a very low risk of counterfeiting and diversion. Mismatches between regions may be associated with a high level of risk of at least one of counterfeiting or diversion. Different actions may be taken depending on the level of risk. For example, in the case of a ‘very high’ risk being identified, an alert may be sent to the manufacturer and to the package handling authorities whereas, in the case of a ‘high’ risk, an alert may be sent to the manufacturer but not to the package handling authorities.

By using such a method, copied UIDs (which may for example be copied at the point of sale) will be detected as they will not be found in the manufacturer's database (or will not be found among active shipments). Diverted products may be identified in transit, rather than at a point of sale.

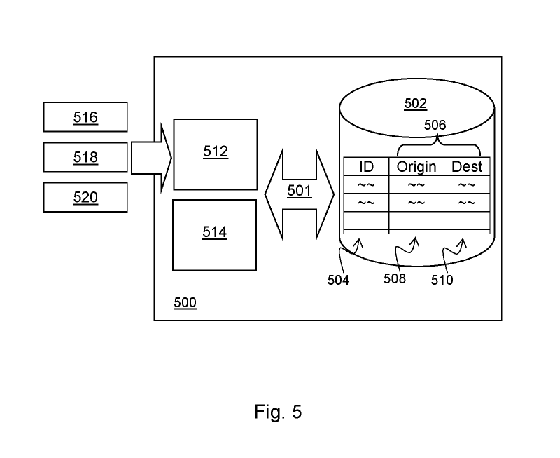

FIG. 5 is an example of a processing apparatus 500 which may for example provide a shipping management system. The processing apparatus 500 comprises an interface 501 (a first interface) to a database 502 storing distribution data 506 associated with each of a plurality of product identifiers 504, the distribution data 506 comprising origin region data 508 and destination region data 510. In this example, the database 502 is integral to the processing apparatus 500, but this may not be the case in all example.

The processing apparatus 500 further comprises an interface 512 (as second interface) to receive a product identifier 516, an origin region 518 and a destination region 520, all of which are acquired from a shipment, and a validation module 514. The validation module 514 to determine if one or both the origin and destination regions acquired for the shipment correspond to the origin and destination region associated with the product identifier stored in the database 502. The region data may for example comprise defined geographical area, at any granularity from a continent to a street address. In some examples, the database 502 may hold a nested list. For example, for each country there may be a list of States/Provinces/Regions, for each State/Province/Region there may be a list of cities, and for each City, there may be a list of postal codes (e.g. ZIP numbers). In some examples, the product identifier may be a first identifier as described above.

In examples in which a database is a remote database, the interface 512 may comprise at least part of an interface to the database 502.

In some examples, the validation module 514 is further to assign a likelihood as to whether the shipment is counterfeit or diverted based on the correspondence or non-correspondence of the regions. In some examples, the validation module 514 is to determine a high likelihood that the shipment is counterfeit if there is non-correspondence between the origin regions respectively acquired from the shipment and stored in the database 502 and correspondence between the destination regions respectively acquired from the shipment and stored in the database 502. The validation module 514 may be to determine a high likelihood that the shipment is diverted if there is a mismatch between the destination regions respectively acquired from the shipment and stored in the database 502 and a match between the origin regions respectively acquired from the shipment and stored in the database 502. The validation module 514 may be to determine a high likelihood that the shipment is diverted or counterfeit if there is a mismatch between origin regions respectively acquired from the shipment and stored in the database 502 and between destination regions respectively acquired from the shipment and stored in the database 502.

In some examples, the database 502 may further comprise an indication of at least one transit region associated with a product identifier, and the interface 512 is further to receive at least one location of the shipment from which the product identifier 504 is acquired, and the validation module 514 is to determine if the shipment location acquired from the shipment correspond to a transit region.

In some examples, the database 502 may comprise a plurality of databases, or a plurality of datasets. In some examples, the interface 512 is to receive a second product identifier associated with a product controlling entity (for example, a manufacturer of the product, a brand owner or the project, a distributor of the product or the like) and the validation module 514 is to determine the database or a dataset thereof using the second product identifier. The database or dataset thereof may comprise data associated with or originating from a product controlling entity.

In some examples, the interface 512 is to send, to a location of the shipment, an indication of the assigned likelihoods. This may for example alert a transit hub, authority or other package handling entity of a possible counterfeiting/diversion risk associated with the product.

In some examples, processing apparatus 500 may be distributed over more than one location.

The processing apparatus 500 may carry out the process of any of FIG. 1, 2 or 4.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited solely by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
acquiring a machine readable first identifier associated with a packaged product;
querying a database using the first identifier to determine distribution data, the distribution data comprising at least one of a destination region and an origin region;
acquiring at least one of a destination region and an origin region from the packaged product as machine readable data,
comparing at least one acquired region with the distribution data and, as a result of a determined correspondence or non-correspondence between the regions,
determining an indication of at least one of a counterfeit status, a diversion status and a valid status for the packaged product.

2. A method according to claim 1 in which the determination of the indication of at least one of the counterfeit status, diversion status and/or valid status comprises a determination of at least one likelihood that the packaged product is counterfeit, diverted or validly transmitted.

3. A method according to claim 2 further comprising generating an alert if at least one of the likelihood that packaged product is counterfeit or the likelihood that packaged product is diverted exceeds a threshold.

4. A method according to claim 1 in which said comparing comprises comparing both the destination region and the origin region acquired from the packaged product with distribution data; and
determining the indication of at least one of a counterfeit status, a diversion status and a valid status is based on whether one of said regions corresponds to the distribution data, both of said regions corresponds to the distribution data or neither of the regions corresponds to the distribution data.

5. A method according to claim 4 in which:
the status provides an indication of likelihood that a packaged product is diverted, counterfeit or valid, wherein
an increased likelihood of diversion is associated with a non-correspondence between the destination region acquired from the packaged product and the destination region in the distribution data;
and an increased likelihood of counterfeiting is associated with a non-correspondence between the origin region acquired from the packaged product and the origin region in the distribution data.

6. A method according to claim 5 comprising
determining a high likelihood that the packaged product is counterfeit if there is a non-correspondence between the origin regions and a correspondence between the destination regions;
determining a high likelihood that the packaged product is diverted if there is a non-correspondence between the destination regions and a correspondence between the origin regions; and
determining a high likelihood that the packaged product is diverted or counterfeit if there is a non-correspondence between origin region and between destination regions.

7. A method according to claim 6 comprising
determining a non-zero likelihood that the packaged product is diverted if there is a non-correspondence between the origin regions and a correspondence between the destination regions.

8. A method according to claim 1 further comprising querying the database to determine if the first identifier is associated with a product which is indicated to be in active shipment and in which determining the indication of at least one of a counterfeit status, a diversion status and a valid status for the packaged product is based on whether the produce is indicated to be in active shipment.

9. A method according to claim 1 in which a second identifier is used to identify a database or a dataset of a database to query using the first identifier.

10. A processing apparatus comprising:
an interface to a database storing distribution data associated with each of a plurality of product identifiers, the distribution data comprising origin region data and destination region data,
an interface to receive a first product identifier, origin region data and destination region data acquired from a shipment; and
a validation module to determine if the origin and/or destination region data acquired from the shipment corresponds to the origin and/or destination region data associated with the product identifier corresponding to the first product identifier stored in the database.

12. A processing apparatus according to claim 11 in which the validation module is further to assign a likelihood as to whether the shipment is counterfeit or diverted based on the correspondence or non-correspondence of the regions.

13. A processing apparatus according to claim 12 in which:
the validation module is to determine a high likelihood that the shipment is counterfeit if there is non-correspondence between the origin region data respectively acquired from the shipment and stored in the database and correspondence between the destination region data respectively acquired from the shipment and stored in the database,
the validation module is to determine a high likelihood that the shipment is diverted if there is a non-correspondence between the destination region data respectively acquired from the shipment and stored in the database and a correspondence between the origin region data respectively acquired from the shipment and stored in the database; and
the validation module is to determine a high likelihood that the shipment is diverted or counterfeit if there is a non-correspondence between origin region data respectively acquired from the shipment and stored in the database and between destination region data respectively acquired from the shipment and stored in the database.

14. A processing apparatus according to claim 12 in which the interface to receive a first product identifier, origin region data and destination region data acquired from a shipment is further to receive a second product identifier associated with a product controlling entity and the validation module is to determine the database using the second product identifier.

15. A processing apparatus according to claim 11 in which:
the database further comprises an indication of at least one transit region associated with a product identifier,
the interface to receive a first product identifier, origin region data and destination region data acquired from a shipment is further to receive at least one location of the shipment from which the product identifier is acquired, and
the validation module is to determine if the shipment location acquired from the shipment correspond to a transit region.
